(19) United States
(12) Patent Application Publication
(10) Pub. No.: US 2026/0056484 A1
(43) Pub. Date: Feb. 26, 2026

(54) TONER PARTICLES HAVING A REDUCED CONTENT OF ARYL AMINES OR N-ARYLACETOACETAMIDES AND OXIDATION METHODS FOR PRODUCING THE SAME

(71) Applicant: Xerox Corporation, Norwalk, CT (US)

(72) Inventors: Jordan A. FRANK, Rochester, NY (US); Jing X. SUN, Lexington, KY (US); Genggeng QI, Webster, NY (US); Daniel W. ASARESE, Honeoye Falls, NY (US); Chieh-Min CHENG, Rochester, NY (US)

(73) Assignee: Xerox Corporation, Norwalk, CT (US)

(21) Appl. No.: 18/813,383

(22) Filed: Aug. 23, 2024

(51) Int. Cl. G03G 9/08; G03G 9/09; G03G 9/093

(52) U.S. Cl. CPC G03G 9/0815; G03G 9/0906; G03G 9/09328

(57) ABSTRACT

Toner particles comprising N-arylacetoacetarylide pigment compositions may contain residual aryl amines in some case. The N-arylacetoacetarylide pigment compositions comprise a diazonium coupling product of a first aryl amine and an N-arylacetoacetamide formed from a second aryl amine. Toner particles containing N-arylacetoacetarylide pigment compositions may be contacted with an oxidant in an aqueous phase to decrease the amount(s) of second aryl amine and/or N-arylacetoacetamide that remain present within the toner particles.

### FIELD

The present disclosure generally relates to printing, and more specifically, to methods for decreasing residual quantities of organic compounds in toner particles.

### BACKGROUND

A variety of pigments may be utilized for imparting color to toner particles. In the present disclosure, the term “pigment” refers equivalently to any of inorganic compounds, organic compounds (inclusive of metal-ligand compounds), and organometallic compounds that may impart color to a specified medium. Toner particles may comprise various types of polymers in which pigments are admixed.

Among the classes of organic compounds that are commonly available for imparting color to toner particles and other media are azo dyes (diazonium coupling products). Azo dyes may be formed by diazotizing an aryl amine to form a diazonium salt, followed by reacting the diazonium salt with another aromatic compound or a nucleophilic carbon atom, such as the central carbon atom in β-dicarbonyl compounds. One such β-dicarbonyl compound that is commonly utilized to form azo dyes is acetoacetic acid (usually in an amidated form through a reaction with another aryl amine, i.e., an N-arylacetoacetamide). Such azo dyes are commonly referred to as N-arylacetoacetarylide pigments.

Although N-arylacetoacetarylide pigments are commonly used in a variety of industries, there are concerns about residual aryl amines and byproducts or intermediates thereof remaining in toner particles following their formation and isolation. One such intermediate that may release aryl amines is the N-arylacetoacetamide compound used in the diazonium salt coupling during production of N-arylacetoacetarylide pigments. Though N-arylacetoacetarylide pigments are considered safe in most cases, aryl amines have known human health concerns and environmental impacts. Consequently, numerous routes have been explored for purifying N-arylacetoacetarylide pigments following their synthesis to lower the content of residual aryl amines and aryl amine byproducts/intermediates to as low a concentration as possible, such as through oxidation. Oxidation may convert the amine group into a nitro group and/or a polyaniline polymer, both of which present lesser concerns than does the aryl amine itself. One difficulty with such oxidation processes is that the extent of removal of aryl amines and N-arylacetoacetamides from pigments may be less than desired and require long oxidation times and/or significant stoichiometric excesses of oxidants. In addition, some oxidation processes may destabilize pigment dispersions, a common form in which N-arylacetoacetarylide pigments are produced commercially and utilized in various processes, including production of toner particles. Corresponding oxidation processes for toner particles have not been adequately explored, likely due to concerns about modifying the color or adhesion properties of the toner particles during printing.

### SUMMARY

In some embodiments, the present disclosure provides methods for treating toner particles. The methods comprise: providing toner particles comprising an N-arylacetoacetarylide pigment composition, the N-arylacetoacetarylide pigment composition comprising a diazonium coupling product of a first aryl amine and an N-arylacetoacetamide formed from a second aryl amine; wherein the N-arylacetoacetarylide pigment composition comprises at least some residual N-arylacetoacetamide that has not undergone diazonium coupling and/or at least some residual second aryl amine that has not reacted to form the N-arylacetoacetamide and/or has hydrolyzed from the N-arylacetoacetamide; and contacting the toner particles with an oxidant in an aqueous phase at a temperature and for a time sufficient to decrease a concentration of at least the residual second aryl amine in the toner particles.

In some or other embodiments, the present disclosure provides toner compositions comprising: toner particles comprising an N-arylacetoacetarylide pigment composition, the N-arylacetoacetarylide pigment composition comprising a diazonium coupling product of a first aryl amine and an N-arylacetoacetamide formed from a second aryl amine; wherein a concentration of residual second aryl amine in the toner particles is about 20 ppm or below.

### BRIEF DESCRIPTION OF THE DRAWINGS

Not applicable.

### DETAILED DESCRIPTION

The present disclosure generally relates to printing, and more specifically, to methods for decreasing residual quantities of organic compounds in toner particles.

As discussed above, N-arylacetoacetarylide pigments may contain residual quantities of aryl amines and N-arylacetoacetamides that may be undesirable and complicate the use of these materials, such as when making and using toner particles. Since N-arylacetoacetamides are often used in a significant stoichiometric excess when forming azo dyes, residual quantities of this intermediate are often relatively high in as-produced N-arylacetoacetarylide pigments. N-arylacetoacetamides are a potential source for releasing free aryl amine during formation or printing of toner particles and/or upon exposure of a printed image to environmental conditions. Hence, in addition to limiting the amount of aryl amines in toner particles, it may also be desirable to limit the amount of residual N-arylacetoacetamides as well.

Direct oxidation of N-arylacetoacetarylide pigments may decrease the amount of aryl amines and N-arylacetoacetamides, though sometimes not to a desired extent. Moreover, oxidation processes may sometimes destabilize N-arylacetoacetarylide pigment dispersions in some cases. Although treatment of N-arylacetoacetarylide pigments may decrease the amount of aryl amines and N-arylacetoacetamides therein, doing so does not address the potential release of aryl amines during subsequent manufacturing of toner particles.

The present disclosure addresses these difficulties and provides related advantages as well. In particular, the present disclosure provides oxidative methods that, instead of being conducted upon the N-arylacetoacetarylide pigment itself, are conducted upon toner particles containing the N-arylacetoacetarylide pigment to decrease the concentration of aryl amine and/or N-arylacetoacetamide intermediates therein. At the least, this approach may avoid potentially destabilizing a pigment dispersion. Additionally, by performing oxidation upon the toner particles themselves, any aryl amines that are released during the toner manufacturing process may be effectively addressed. Surprisingly, such oxidation processes do not appreciably impact the toner particles or processes for forming toner particles by emulsion aggregation-coalescence.

Without being bound by theory or mechanism, the oxidation chemistry is believed to promote removal of aryl amines by forming a radical intermediate through oxidation of the amine group. In a first reaction pathway, the radical intermediate may undergo conversion to the corresponding aryl nitro compound. In a second reaction pathway, the radical intermediate may undergo polymerization to form the corresponding polyaniline. Neither of these entities present the concerns associated with aryl amines, even if the oxidation product remains within the toner particles.

Continuing to remain unbound by theory or mechanism, the oxidation chemistry may further promote removal of aryl amines by degrading N-arylacetoacetamides into their constituent aryl amines and acetoacetic acid, either through direct hydrolysis or by first converting the N-arylacetoacetamide into the corresponding N-aryl-N-hydroxyacetoacetamide, followed by hydrolysis to the corresponding aryl hydroxylamine. In either case, the aryl amine or aryl hydroxylamine may undergo conversion to the corresponding aryl nitro compound and/or the corresponding polyaniline according to the description above. Thus, by decreasing the concentration of N-arylacetoacetamide within the toner particles, risks associated with potential formation of aryl amines in the toner particles may also be reduced.

The methods of the present disclosure may be conducted during the coalescence stage of forming toner particles, upon a slurry of toner particles obtained from a toner manufacturing process, or upon toner solids isolated following a toner manufacturing process. Surprisingly, introduction of the oxidant during the coalescence stage does not appreciably impact the coalescence process or the properties of the resulting toner particles. Thus, the methods of the present disclosure offer considerable flexibility in how removal of aryl amines and N-arylacetoacetamides from toner particles may take place.

Accordingly, methods of the present disclosure may comprise: providing toner particles comprising an N-arylacetoacetarylide pigment composition, the N-arylacetoacetarylide pigment composition comprising a diazonium coupling product of a first aryl amine and an N-arylacetoacetamide formed from a second aryl amine, in which the N-arylacetoacetarylide pigment composition comprises at least some residual N-arylacetoacetamide that has not undergone diazonium coupling and/or at least some residual second aryl amine that has not reacted to form the N-arylacetoacetamide and/or has hydrolyzed from the N-arylacetoacetamide; and contacting the toner particles with an oxidant in an aqueous phase at a temperature and for a time sufficient to decrease a concentration of the residual N-arylacetoacetamide and/or the residual second aryl amine in the toner particles.

Suitable toner particles are not believed to be particularly limited in the methods of the present disclosure, provided that the components of the toner particles are not adversely affected by the oxidant. In non-limiting examples, the toner particles may comprise at least one polymer such as, for example, polyesters, polystyrenes (e.g., a polystyrene-co-acrylate copolymer), poly(meth)acrylates, poly(meth)acrylic acids, any copolymer thereof, or any combination thereof. Preferably, the toner particles may be core-shell toner particles, which may be prepared by emulsion aggregation-coalescence processes. Additional details regarding emulsion aggregation-coalescence processes for forming toner particles, particularly with respect to utilization of an oxidant during or after the emulsion aggregation-coalescence processes, is provided hereinbelow. It is to be appreciated that the emulsion aggregation-coalescence description herein is intended to be illustrative in nature, and one having ordinary skill in the art may suitably modify other toner production techniques to incorporate an oxidant in order to realize the benefits described herein.

Contacting the toner particles with the oxidant may be conducted over a range of pH values, which may be acidic, basic (alkaline), or neutral, depending on the type of oxidant and the stage of toner particle formation at which the toner particles are contacted with the oxidant. An aqueous phase having an acidic or alkaline pH value may promote oxidation at a faster rate than under substantially neutral conditions. In some embodiments, the oxidation may be conducted with the aqueous phase having an alkaline pH value. In non-limiting examples, the aqueous phase may have a pH of about 7.1 to about 14, or about 8 to about 12, or about 9 to about 14, or about 7.5 to about 13, or about 8.5 to about 14, or about 9 to about 13, or about 10 to about 14, or about 9.5 to about 12.5, or about 8 to about 9.

An alkaline pH value may be maintained by combining a suitable base with the aqueous phase containing the oxidant. In some examples, a hydroxide compound may be combined with the aqueous phase to reach a desired pH value for treating the toner particles. For example, ammonium hydroxide (aqueous ammonia) or an alkali metal hydroxide, such as sodium hydroxide or potassium hydroxide, may be present. In some examples, a carbonate or bicarbonate salt may be combined with the aqueous phase to reach a desired pH value. For example, ammonium carbonate or bicarbonate or an alkali metal carbonate or bicarbonate may be combined with the aqueous phase to reach a desired pH value. In still other examples, a hydroxide compound and a carbonate or bicarbonate salt may be used in combination with one another. Without being bound by theory or mechanism, the carbonate or bicarbonate salt may buffer the aqueous phase to aid in maintaining the alkaline pH value as the oxidation reaction proceeds. Acidic compounds released during the oxidation reaction may also be neutralized by hydroxide compounds, carbonate salts, bicarbonate salts, or any combination thereof.

The oxidant may comprise a persulfate salt, a hypochlorite salt, or any combination thereof. Such oxidants are typically more effective at alkaline pH values. Suitable persulfate salts may include, but are not limited to, ammonium persulfate or alkali metal persulfates, such as sodium persulfate, potassium persulfate, or any combination thereof. Suitable hypochlorite salts may include, for example, sodium hypochlorite, preferably an aqueous alkaline solution thereof.

The amount of oxidant may be chosen to afford a desired degree of removal of the second aryl amine and/or the N-arylacetoacetamide. The oxidant may be present in at least a stoichiometric (at least one molar equivalent) amount relative to a total amount of the second aryl amine in the N-arylacetoacetarylide pigment composition, the total amount of the second aryl amine being a combined amount of free second aryl amine and amidated second aryl amine that is present in the N-arylacetoacetamide. In non-limiting examples, the oxidant may be present in an amount of about 1.5 molar equivalents or greater, or about 2.5 molar equivalents or greater, or about 5 molar equivalents or greater, or about 10 molar equivalents or greater, or about 15 molar equivalents or greater, or about 20 molar equivalents or greater, each measured relative to the total amount of the second aryl amine in the pigment composition. For instance, suitable amounts of the oxidant relative to the total amount of the second aryl amine may range from about 1.1 molar equivalents to about 30 molar equivalents, or about 1.5 molar equivalents to about 3 molar equivalents, or about 1.5 molar equivalents to about 5 molar equivalents, or about 3 molar equivalents to about 5 molar equivalents, or about 3 molar equivalents to about 10 molar equivalents, or about 5 molar equivalents to about 20 molar equivalents, or about 10 molar equivalents to about 20 molar equivalents, or about 10 molar equivalents to about 15 molar equivalents. Alternately, the oxidant may be present relative to the N-arylacetoacetamide within the foregoing ranges (i.e., the amount of oxidant relative to the N-arylacetoacetamide may range from about 1.1 to about 30 molar equivalents or any subrange thereof). The oxidation reaction may take place exposed to air or pressurized air.

Depending on the chosen oxidant and the amount thereof, the oxidation reaction may be conducted over a range of temperatures that are effective to decrease concentrations of the second aryl amine and/or the N-arylacetoacetamide to a sufficient degree. In non-limiting examples, the oxidation reaction may be conducted at a temperature of about 25° C. to about 100° C., or about 50° C. to about 95° C., or about 60° C. to about 90° C., or about 70° C. to about 85° C., or about 70° C. to about 90° C. The oxidation reaction may be conducted at atmospheric pressure or at an elevated pressure. Higher oxidation temperatures than the foregoing may be utilized if an elevated pressure vessel is used.

Furthermore, the oxidation reaction may be conducted for a length of time sufficient to decrease the concentration of the second aryl amine and/or the N-arylacetoacetamide to a desired degree. In non-limiting examples, the length of time may be about 1 hour or greater, or about 2 hours or greater, or about 3 hours or greater, or about 4 hours or greater, or about 6 hours or greater, or about 8 hours or greater, or about 16 hours or greater, or about 24 hours or greater. For instance, the oxidation reaction may be conducted for about 1 hour to about 4 hours, or about 2 hours to about 4 hours, or about 3 hours to about 6 hours, or about 6 hours to about 18 hours, or about 12 hours to about 24 hours. The amount of time over which the oxidation reaction takes place may depend on the extent to which lowering of the concentration of the second aryl amine and/or the N-arylacetoacetamide is needed, the chosen oxidant, the chosen pH, and the chosen temperature at which the oxidation reaction takes place.

The methods of the present disclosure may be effective to decrease the concentration of the second aryl amine and/or the N-arylacetoacetamide to a desired degree. In non-limiting examples, the methods of the present disclosure may remove at least about 30%, or at least about 40%, or at least about 50%, or at least about 60%, or at least about 70%, or at least about 80%, or at least about 85%, or at least about 90% of the second aryl amine, as measured on a mass basis relative to the amount of the second aryl amine in the toner particles. For instance, the methods of the present disclosure may decrease the concentration of the second aryl amine in the toner particles by about 30% to about 60%, or about 60% to about 95%, or about 70% to about 90%, or about 65% to about 85%, as measured on a mass basis relative to the amount of the second aryl amine in the toner particles without using the oxidant.

In more specific examples, following oxidation, the toner particles oxidized according to the description herein may contain an amount of residual second aryl amine that is about 40 ppm or below, or about 30 ppm or below, or about 20 ppm or below, or about 10 ppm or below, such as about 30 ppm to about 10 ppm, or about 25 ppm to about 10 ppm.

Any N-arylacetoacetarylide containing a residual N-arylacetoacetamide and/or aryl amine may be mitigated through use of the disclosure herein. Examples of the second aryl amines that may be present, either alone and/or in amidated form, may include, but are not limited to, aniline, 2-chloroaniline, 3-chloroaniline, 4-chloroaniline, 2-methylaniline (o-toludine), 3-methylaniline, 4-methylaniline, 2,4-dimethylaniline, 2-methoxyaniline (o-anisidine), 3-methoxyaniline, 4-methoxyaniline, 2,4,5-trimethoxyaniline, 4-chloro-2,5-dimethoxyaniline, 5-amino-1,3-dihydro-2H-benzo[d]imidazol-2-one, and the like. Example pigment compositions in which the aryl amines may be present include, but are not limited to, Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 83, Pigment Yellow 97, Pigment Yellow 151, Pigment Yellow 154, Pigment Yellow 180, Pigment Yellow 194, or any combination thereof.

Toner particles may be prepared by any suitable process for forming the toner particles in a desired size and shape and are not particularly limited unless incompatible with the oxidant. In some examples, the toner particles may be prepared by an emulsion aggregation-coalescence process. Specific examples of such processes are described in brief hereinafter in the interest of providing a complete description of how an oxidant may be utilized to decrease an amount of aryl amines in the toner particles according to one or more aspects of the disclosure herein. Additional details of emulsion aggregation-coalescence processes for forming toner particles will be familiar to persons having ordinary skill in the art.

Examples of emulsion-aggregation toner particle production methods that may be suitably utilized to form toner particles for use herein and/or modified to incorporate an oxidant during the coalescence stage may include, for instance, those described in U.S. Pat. Nos. 5,364,729, 5,496,676, 5,501,935, 5,919,595, 6,132,924, 6,495,302, 6,268,102, 6,500,597, and 6,416,920, the disclosures of each of which are hereby incorporated by reference in their entirety. Illustrative polyester-based toners and toner production processes that may be suitable or suitably modified include those described in U.S. Pat. No. 11,092,906, which is also incorporated herein by reference in its entirety.

Emulsion aggregation (EA) processes may take place by aggregating a mixture of one or more emulsions, which may comprise a polymer resin or mixture of polymer resins, such as an amorphous polyester, a crystalline polyester, or a polystyrene (e.g., a poly(styrene-acrylate) copolymer) for forming core particles. Other polymer resins may also be suitable. The emulsion may further comprise a wax in emulsified form, such as a paraffin wax or a Fischer-Tropsch polymethylene wax. The emulsion may further comprise a pigment dispersion, which may comprise any of the N-arylacetarylide pigments disclosed herein. The emulsion may be referred to as a latex in the discussion that follows. Following emulsion aggregation, the processes may further comprise a coalescence stage, in which the particle size of the toner particles may increase and/or become more spherical in shape.

A shell resin may be added to form core-shell particles during the coalescence stage. The shell resin may be the same as or different than the core resin.

In some embodiments, processes for producing a toner may comprise combining a first amorphous polyester, a second amorphous polyester different from the first amorphous polyester, a paraffin wax or a polymethylene wax; a crystalline polyester; and an N-arylacetoacetarylide pigment to prepare a latex; optionally, adding an aggregating agent to the latex; heating the latex to form aggregated toner particles; adding a shell resin to the aggregated toner particles, the shell resin comprising at least one amorphous polyester; and heating to coalesce the particles forming coalesced toner particles; and recovering the coalesced toner particles.

Optionally, an oxidant may be included during the coalescence stage to decrease amounts of aryl amine according to the description herein. Oxidation may take place during the coalescence stage at the coalescence temperature. The coalescence temperature is above the glass transition temperature of the toner particles.

In the present disclosure, the glass transition temperature may be determined by differential scanning calorimetry over a temperature range of 0-140° C. with a 3° C./minute ramping rate. The temperature is also modulated +/−0.48° C. every 60 seconds.

When used, suitable aggregating agents include, for example, aqueous solutions of a multi-valent agent such as a polyaluminum halide such as polyaluminum chloride (PAC), a polyaluminum silicate such as polyaluminum sulfosilicate (PASS), or a water-soluble metal salt such as aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, or combinations thereof. The aggregating agent may be added to the mixture at a temperature that is below the glass transition temperature of the resin(s).

When used, the aggregating agent may be added to the emulsion in any suitable or desired amount such as, for example, from about 0% to about 10% by mass of the resin, from about 0.2% to about 8% by mass of the resin, or from about 0.5% to about 5% by mass of the resin.

The particles of the emulsion may be permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for volume average particle size (D50). The aggregation thus may proceed by maintaining an elevated temperature, or slowly raising the temperature to near the glass transition temperature such as, for example, in embodiments, from about 30° C. to about 100° C., or about 30° C. to about 80° C., or about 30° C. to about 50° C. The temperature may be held for a period of time from about 0.5 hours to about 6 hours, or about hour 1 to about 5 hours, while stirring, to provide aggregated toner particles. Once the pre-determined desired particle size is reached, a shell resin may be added. The volume average particle size of the particles prior to introduction of the shell resin may be, for example, from about 3 μm to about 10 μm, or about 4 μm to about 9 μm, or about 6 μm to about 8 μm.

As described herein, the toner particles may have a core-shell structure. After aggregation, but prior to coalescence, a resin coating may be applied to the aggregated particles to form a shell surrounding the core. The shell may comprise the same as or different polymer than the core. Any of the resins described above may be utilized in the shell. In some embodiments, an amorphous polyester resin may be utilized in the shell. In some embodiments, the shell may comprise a first amorphous polyester and a second amorphous polyester. In some embodiments, the shell may comprise a first amorphous polyester and a second amorphous polyester and is free of other resins. In some embodiments, two amorphous polyester resins may be utilized in the shell, in equal or non-equal amounts. In embodiments, a crystalline polyester resin and two different types of amorphous polyester resin may be utilized in the core and the same two types of amorphous polyester resins may be utilized in the shell.

In some embodiments, the toner particles described herein may comprise polyester toner particles, which may be free of other types of resins, such as styrene, acrylate, or other resins. In other embodiments, the toner particles described herein may be polystyrene toner particles and have an acrylate resin shell at least partially surrounding a polystyrene core. Alternative polymers for forming toner particles may employ emulsion aggregation-coalescence processes similar to those used for forming toner particles from polyesters.

In some embodiments, the shell resin(s) may comprise a first amorphous polyester comprising a poly(propoxylated bisphenol-co-terephthalate-fumarate-dodecenylsuccinate) and a second amorphous polyester comprising a poly(propoxylated-ethoxylated bisphenol-co-terephthalate-dodecenylsuccinate-trimellitic anhydride).

The shell may be applied to the aggregated particles by using the shell resins in the form of emulsion(s) as described above. Such emulsions may be combined with the aggregated particles under conditions sufficient to form a coating over the aggregated particles. For example, formation of the shell over the aggregated particles may occur while heating at a temperature of about 30° C. to about 80° C., or about 35° C. to about 70° C. Formation of the shell may take place for a period of time from about 5 minutes to about 10 hours or from about 10 minutes to about 5 hours.

Once a desired size of the toner particles is achieved, the pH may be adjusted with a pH control agent (a base) to a value of about 3 to about 10, or about 5 to about 9, or about 7.1 to about 10. Adjustment of the pH may be utilized to freeze (stop) toner growth. The base utilized to stop toner growth may include any suitable base such as, for example, alkali metal hydroxides such as, for example, sodium hydroxide, potassium hydroxide, ammonium hydroxide, combinations thereof, and the like. In embodiments, a chelating agent such as ethylenediamine tetraacetic acid (EDTA) may be added to help adjust the pH to the desired values noted above. Other chelating agents may be used.

Prior to coalescence, the size of the core-shell toner particles may range from about 3 μm to about 10 μm, or about 4 μm to about 10 μm, or about 5 μm to about 8 μm. In some examples, even smaller toner particles may be used.

Following aggregation to the desired particle size and application of the shell, the particles may then be coalesced to a desired final shape, preferably with high circularity, the coalescence being achieved by, for example, heating at a temperature above the glass transition temperature, such as about 70° C. to about 100° C., or about 80° C. to about 95° C., or about 85° C. to about 98° C. or even about 99° C. Heating may continue or the pH of the mixture may be adjusted (e.g., reduced) over a period of time until a desired circularity is reached. The period of time may be from about 1 hour to about 5 hours or from about 2 hours to about 4 hours. Various buffers may be used during coalescence. The total time period for coalescence may be about 1 hour to about 9 hours, or about 1 hour to about 8 hours, or about 1 hour to about 5 hours. The circularity may be about 0.95 or greater, or about 0.96 or greater, or about 0.97 or greater, or about 0.98 or greater, or about 0.99 or greater. As used herein, the terms “circularity” and “sphericity” relative to the particles refer to how close the particle is to a perfect sphere. To determine circularity, optical microscopy images are taken of the particles. The perimeter (P) and area (A) of the particle in the plane of the microscopy image is calculated (e.g., using a SYSMEX FPIA 3000 particle shape and particle size analyzer, available from Malvern Instruments). The circularity of the particle is C_{EA}/P, where C_{EA} is the circumference of a circle having the area equivalent to the area (A) of the actual particle.

After aggregation and/or coalescence, the mixture may be cooled to room temperature. The cooling may be rapid or slow, as desired. A suitable cooling process may include introducing cold water to a jacket around the reactor, for example. After cooling, the toner particles may be screened with a sieve of a desired size, filtered, washed with water, and then dried. Drying may be accomplished by any suitable process for drying including, for example, freeze-drying.

Embodiments disclosed herein include the following:

Embodiment 1. A method comprising:
providing toner particles comprising an N-arylacetoacetarylide pigment composition, the N-arylacetoacetarylide pigment composition comprising a diazonium coupling product of a first aryl amine and an N-arylacetoacetamide formed from a second aryl amine;
   wherein the N-arylacetoacetarylide pigment composition comprises at least some residual N-arylacetoacetamide that has not undergone diazonium coupling and/or at least some residual second aryl amine that has not reacted to form the N-arylacetoacetamide and/or has hydrolyzed from the N-arylacetoacetamide; and
contacting the toner particles with an oxidant in an aqueous phase at a temperature and for a time sufficient to decrease a concentration of at least the residual second aryl amine in the toner particles.

Embodiment 2. The method of Embodiment 1, wherein the toner particles are core-shell toner particles and/or are prepared by an emulsion aggregation-coalescence process.

Embodiment 3. The method of Embodiment 2, wherein the toner particles are prepared by the emulsion aggregation-coalescence process and are contacted with the oxidant during at least a portion of a coalescence stage of the emulsion aggregation-coalescence process.

Embodiment 4. The method of Embodiment 3, wherein the coalescence stage takes place at a temperature above a glass transition temperature of the toner particles.

Embodiment 5. The method of Embodiment 1 or Embodiment 2, wherein the toner particles are obtained as a toner slurry from a toner production process, and the toner slurry is contacted with the oxidant.

Embodiment 6. The method of Embodiment 1 or Embodiment 2, wherein the toner particles are isolated as a solid prior to being contacted with the oxidant.

Embodiment 7. The method of any one of Embodiments 1-6, wherein the oxidant comprises a persulfate salt, a hypochlorite salt, or any combination thereof.

Embodiment 8. The method of any one of Embodiments 1-7, wherein a hydroxide compound, a carbonate salt, a bicarbonate salt, or any combination thereof is present in combination with the oxidant.

Embodiment 9. The method of any one of Embodiments 1-8, wherein the oxidant comprises a persulfate salt, and the temperature is about 25° C. to about 95° C.

Embodiment 10. The method of Embodiment 9, wherein the time is about 0.5 hours to about 24 hours.

Embodiment 11. The method of any one of Embodiments 1, 2, or 5-8, wherein the oxidant comprises a hypochlorite salt, and the temperature is about 25° C. to about 50° C.

Embodiment 12. The method of any one of Embodiments 1-11, wherein the N-arylacetoacetarylide pigment composition comprises an N-arylacetoacetarylide selected from the group consisting of Pigment Yellow 17, Pigment Yellow 74, Pigment Yellow 83, Pigment Yellow 180, and any combination thereof.

Embodiment 13. The method of any one of Embodiments 1-12, wherein the second aryl amine is o-anisidine.

Embodiment 14. The method of any one of Embodiments 1-13, wherein the temperature and time are sufficient to decrease the concentration of the second aryl amine by at least about 70% on a mass basis relative to an amount of the second aryl amine in the toner particles.

Embodiment 15. A toner composition comprising:
toner particles comprising an N-arylacetoacetarylide pigment composition, the N-arylacetoacetarylide pigment composition comprising a diazonium coupling product of a first aryl amine and an N-arylacetoacetamide formed from a second aryl amine;
   wherein a concentration of residual second aryl amine in the toner particles is about 20 ppm or below.

Embodiment 16. The toner composition of Embodiment 15, wherein the toner particles are core-shell toner particles and/or are prepared by an emulsion aggregation-coalescence process.

Embodiment 17. The toner composition of Embodiment 15 or Embodiment 16, wherein the N-arylacetoacetarylide pigment composition comprises an N-arylacetoacetarylide selected from the group consisting of Pigment Yellow 17, Pigment Yellow 74, Pigment Yellow 83, Pigment Yellow 180, and any combination thereof.

Embodiment 18. The toner composition of any one of Embodiments 15-17, wherein the second aryl amine is o-anisidine.

To facilitate a better understanding of the present disclosure, the following examples of preferred or representative embodiments are given. In no way should the following examples be read to limit, or to define, the scope of the invention.

### Examples

Samples were analyzed by liquid chromatography (LC) with UV detection for o-anisidine (OA) and the o-anisidine amide of acetoacetic acid (AAOA). For the LC/UV chromatography, the samples were vortexed for 5 minutes, and 0.5 g sample was weighed into a 20 mL scintillation vial and combined with 5 mL THF. The sample was mechanically shaken for 60 minutes and then combined with 15 mL methanol, followed by an additional 60 minutes of mechanical shaking. Finally, the sample was diluted 10-fold with deionized water and filtered through a 0.2 μm nylon filter. LC separation was conducted at 50° C. on an Agilent 1280 LC system with a Poroshell 120 EC-C18 2.7 μm column at a flow rate of 1 mL/min and a gradient from 27% methanol/73% 12 mM ammonium acetate to 100% methanol over 8 minutes. UV detection was conducted at 281 nm.

Polyester-Based Toner Preparation Process (Comparative Example 1). Polyester-based toner particles were prepared using an emulsion aggregation-coalescence process. Polyester latex core particles, PY-74 pigment, wax, and deionized water were combined in a reactor. The pH was adjusted to 4.2 using 0.3 M aqueous nitric acid. Aluminum sulfate flocculant was added and slurry was homogenized, followed by heating to 45-50° C. for aggregation. The particle size (D50) was monitored using a Coulter Multisizer-3 instrument. The solids content at this stage was about 14 wt %. At a D50 value of about 5.2-5.4 μm, an aqueous shell polyester latex mixture having a pH of 3.3-4.5 (adjusted with 0.3 M aqueous nitric acid) was added to the core particle mixture using a metered pump at a rate to achieve a D50 of about 6.1-6.3 μm. After 60 minutes, the reaction was stopped by addition of 1 M aqueous sodium hydroxide solution and a chelating agent (VERSENE 100) solution until a pH of 7.8-8.2 was reached, and the mixture was then heated to 75° C. for coalescence. Aqueous 1 M sodium hydroxide solution was slowly added to the resulting slurry during the temperature ramp-up to maintain the pH at about 7.6-8.0. The mixture was held at the coalescence temperature, and the particle circularity was monitored using a FPIA Sysmex3000 instrument. An aqueous 0.3 M nitric acid solution containing an alkylbenzenesulfonate surfactant was added to lower the pH and increase the rate of coalescence. After 3 hours at the coalescence temperature, the mixture was passed through a heat exchanger to quickly lower the temperature below the glass transition temperature, such as to about 40° C., to produce a slurry of solidified toner particles. The solidified toner particles in the slurry were then filtered, washed, and dried using typical methods to produce dry toner particles. The OA and AAOA contents of the toner particles are specified in the tables below.

Poly(styrene-n-butyl acrylate) Copolymer-Based Toner Preparation Process (Comparative Example 2). Poly(styrene-n-butyl acrylate) copolymer-based toner particles were prepared using an emulsion aggregation-coalescence process as follows. Poly(styrene-n-butyl acrylate) copolymer latex core particles, PY-74 pigment, wax, and deionized water were combined in a reactor. The reactor contents were homogenized using a rotor/stator homogenizer, and polyaluminum chloride flocculant was added. The reactor was then heated to 52-59° C. for aggregation. The particle size (D50) was monitored using a Coulter Multisizer-3 instrument. The solids content at this stage was about 14 wt %. At a D50 value of about 5.7 μm, shell latex composed of poly(styrene-n-butyl acrylate) copolymer was added to the reactor using a metered pump. After 30 minutes, the slurry pH was increased to 4.6-4.8 by adding an aqueous 1 M NaOH solution and a chelating agent (VERSENE™ 100) solution. The batch was then held for 10 minutes before heating to about 80° C. Aqueous 0.3 M nitric acid solution was added to lower the pH to 3.7-4.0, followed by heating to a coalescence temperature of 98° C. The reactor was held at the coalescence temperature until a circularity of 0.966 was achieved over 2.5 hours, as determined using a FPIA Sysmex 3000 instrument. An aqueous 1 M sodium hydroxide solution was then added to raise the pH to 6.0, and the reactor was then cooled to about 54° C. The pH was then further raised to 8.8 using 1 M aqueous sodium hydroxide solution. The reactor was then cooled to room temperature to produce a slurry of solidified toner particles. The solidified toner particles in the slurry were then filtered, washed, and dried using typical methods to produce dry toner particles. The OA and AAOA contents of the toner particles are specified in the tables below.

Example 1. Toner slurry was prepared as in Comparative Example 1. The slurry was filtered to obtain a wet filter cake with a solids content of about 56%. 10 g of the wet filter cake was contacted with an aqueous solution containing 28 mg ammonium persulfate (4.5 molar equivalents of oxidant relative to total o-anisidine and o-anisidine acetoacetamide), 28 mg of sodium bicarbonate, and 25 g deionized water. The resulting mixture was stirred at 25° C. and samples were taken at 1, 2, 4, and 20 hours of reaction time. At the end of each reaction time, the toner particles were collected by filtration, washed twice with deionized water, and dried at 37° C. for further analysis. Analytical results are shown in Table 1.

Example 2. Toner particles were prepared and treated as in Example 1, except the aqueous solution contained 56 mg ammonium persulfate (8.9 molar equivalents of oxidant relative to total o-anisidine and o-anisidine acetoacetamide), 56 mg sodium bicarbonate, and 25 g deionized water. Analytical results are shown in Table 1.

Example 3. Toner particles were prepared and treated as in Example 1, except the aqueous solution contained 112 mg ammonium persulfate (17.8 molar equivalents of oxidant relative to total o-anisidine and o-anisidine acetoacetamide), 112 mg sodium bicarbonate, and 25 g deionized water. Analytical results are shown in Table 1.

Example 4. Toner particles were prepared and treated as in Example 1, except the aqueous solution contained 168 mg ammonium persulfate (26.7 molar equivalents of oxidant relative to total o-anisidine and o-anisidine acetoacetamide), 168 mg sodium bicarbonate, and 25 g deionized water. Analytical results are shown in Table 1.

TABLE 1

| | Molar | | | |
|---|---|---|---|---|
| | Equiv. of | | | |
| Example | APS | Treatment | OA | AAOA |
| # | Oxidant | Time (hr) | (ppm) | (ppm) |
| Comp. | 0 | n/a | 27 | 600 |
| Ex. 1 | | | | |
| Ex. 1 | 4.5 | 1 | 25 | 650 |
| | 4.5 | 2 | 24 | 650 |
| | 4.5 | 4 | 21 | 630 |
| | 4.5 | 20 | 16 | 620 |
| Ex. 2 | 8.9 | 1 | 24 | 630 |
| | 8.9 | 2 | 22 | 620 |
| | 8.9 | 4 | 19 | 630 |
| | 8.9 | 20 | 14 | 610 |
| Ex. 3 | 17.8 | 1 | 23 | 620 |
| | 17.8 | 2 | 22 | 630 |
| | 17.8 | 4 | 18 | 610 |
| | 17.8 | 20 | 14 | 600 |
| Ex. 4 | 26.7 | 1 | 20 | 620 |
| | 26.7 | 2 | 19 | 610 |
| | 26.7 | 4 | 17 | 600 |
| | 26.7 | 20 | 14 | 580 |

Example 5. Toner slurry was prepared as in Comparative Example 1. 100 g of toner slurry, having a solids content of about 14%, was combined with 140 mg sodium hypochlorite solution (10-15% available chlorine, 3.4 molar equivalents of oxidant relative to total o-anisidine and o-anisidine acetoacetamide). The resulting mixture was stirred at 25° C. and samples were taken at 1, 2, 4, and 20 hours of reaction time. At the end of each reaction time, the toner particles were collected by filtration, washed twice with deionized water, and dried at 37° C. for further analysis. Analytical data for this example is shown in Table 2.

Example 6. Toner particles were prepared and treated as in Example 5, except 420 mg sodium hypochlorite solution (10.3 molar equivalents of oxidant relative to total o-anisidine and o-anisidine acetoacetamide) was used to conduct the oxidation reaction. Analytical data for this example is shown in Table 2.

Example 7. Toner particles were prepared and treated as in Example 5, except 420 mg sodium hypochlorite solution (10.3 molar equivalents of oxidant relative to total o-anisidine and o-anisidine acetoacetamide) was used to conduct the oxidation reaction, and the oxidation reaction was conducted for 1 hour at 30° C. Analytical data for this example is shown in Table 2.

Example 8. Toner particles were prepared and treated as in Example 5, except 420 mg sodium hypochlorite solution (10.3 molar equivalents of oxidant relative to total o-anisidine and o-anisidine acetoacetamide) was used to conduct the oxidation reaction, and the oxidation reaction was conducted for 1 hour at 50° C. Analytical data for this example is shown in Table 2.

TABLE 2

| | Molar | | | | |
|---|---|---|---|---|---|
| | Equiv. of | | | | |
| Example | NaOCl | Treatment | Treatment | OA | AAOA |
| # | Oxidant | Time (hr) | Temp (° C.) | (ppm) | (ppm) |
| Comp. | 0 | n/a | n/a | 27 | 600 |
| Ex. 1 | | | | | |
| Ex. 5 | 3.4 | 1 | 25 | 15 | 580 |
| | 3.4 | 2 | 25 | 14 | 580 |
| | 3.4 | 4 | 25 | 14 | 580 |
| | 3.4 | 20 | 25 | 14 | 580 |
| Ex. 6 | 10.3 | 1 | 25 | 14 | 560 |
| | 10.3 | 2 | 25 | 14 | 540 |
| | 10.3 | 4 | 25 | 14 | 540 |
| | 10.3 | 20 | 25 | 14 | 510 |
| Ex. 7 | 10.3 | 1 | 30 | 13 | 530 |
| Ex. 8 | 10.3 | 1 | 50 | 19 | 350 |

Example 9. Toner slurry was prepared as in Comparative Example 1. The slurry was filtered to obtain a wet filter cake with a solids content of about 56%. 10 g of the wet filter cake was contacted with an aqueous solution containing 56 mg ammonium persulfate (8.9 molar equivalents of oxidant relative to total o-anisidine and o-anisidine acetoacetamide), 56 mg of sodium bicarbonate, and 25 g of the mother liquor obtained during filtration of the slurry. The resulting mixture was stirred at 25° C. and samples were taken at 1, 2, 4, and 20 hours of reaction time. At the end of each reaction time, the toner particles were collected by filtration, washed twice with deionized water, and dried at 37° C. for further analysis. Analytical results are shown in Table 3.

Example 10. Toner particles were prepared and treated as in Example 9, except the aqueous solution contained 168 mg ammonium persulfate (26.7 molar equivalents of oxidant relative to total o-anisidine and o-anisidine acetoacetamide), 168 mg sodium bicarbonate, and 25 g of the mother liquor obtained during filtration of the slurry. Analytical results are shown in Table 3.

TABLE 3

| | Molar | | | | |
|---|---|---|---|---|---|
| | Equiv. of | | | | |
| Example | APS | Treatment | Treatment | OA | AAOA |
| # | Oxidant | Time (hr) | Temp (° C.) | (ppm) | (ppm) |
| Comp. | 0 | n/a | n/a | 27 | 600 |
| Ex. 1 | | | | | |
| Ex. 9 | 8.9 | 1 | 25 | 23 | 610 |
| | 8.9 | 2 | 25 | 22 | 610 |
| | 8.9 | 4 | 25 | 21 | 610 |
| | 8.9 | 20 | 25 | 15 | 570 |
| Ex. 10 | 26.7 | 1 | 25 | 22 | 590 |
| | 26.7 | 2 | 25 | 21 | 610 |
| | 26.7 | 4 | 25 | 19 | 600 |
| | 26.7 | 20 | 25 | 13 | 520 |

Example 11. Polyester-based toner particles were prepared using an emulsion aggregation-coalescence process. Polyester latex core particles, PY-74 pigment, wax, and deionized water were combined in a reactor. The pH was adjusted to 4.2 using 0.3 M aqueous nitric acid. Aluminum sulfate flocculant was added and the slurry was homogenized, followed by heating to 45-50° C. for aggregation. The particle size (D50) was monitored using a Coulter Multisizer-3 instrument. The solids content at this stage was about 14 wt %. At a D50 value of about 5.2-5.4 μm, an aqueous shell polyester latex mixture having a pH of 3.3-4.5 (adjusted with 0.3 M aqueous nitric acid) was added to the core particle mixture using a metered pump at a rate to achieve a D50 of about 6.1-6.3 μm. After 60 minutes, the reaction was stopped by addition of 1 M aqueous sodium hydroxide solution and a chelating agent (VERSENE 100) solution until a pH of 7.8-8.2 was reached. The mixture was then heated to 85° C. for coalescence. Aqueous 1 M sodium hydroxide solution was slowly added to the resulting slurry during the temperature ramp-up to maintain the pH at about 7.6-8.0. The mixture was held at the coalescence temperature and the particle circularity was monitored using a FPIA Sysmex3000 instrument. A mixture of 55 g ammonium persulfate, 60 g sodium bicarbonate, alkylbenzene sulfonate surfactant, and deionized water was then added. After 3 hours at the coalescence temperature, the mixture was passed through a heat exchanger to quickly lower the temperature below the glass transition temperature, such as to about 40° C., to produce a toner slurry containing solidified toner particles. The solidified toner particles in the slurry were then filtered, washed, and dried using typical methods to produce dry toner particles. Analytical data for this example is shown in Table 4.

TABLE 4

| | Molar | | | | |
|---|---|---|---|---|---|
| | Equiv. of | | | | |
| Example | APS | Treatment | Treatment | OA | AAOA |
| # | Oxidant | Time (hr) | Temp (° C.) | (ppm) | (ppm) |
| Comp. | 0 | n/a | n/a | 27 | 600 |
| Ex. 1 | | | | | |
| Ex 11 | 4.5 | n/a | 85 | 16 | 510 |

Example 12. Poly(styrene-n-butyl acrylate) copolymer-based toner particles were prepared using an emulsion aggregation-coalescence process as follows. Poly(styrene-n-butyl acrylate) latex core particles, PY-74 pigment, wax, and deionized water were combined in a reactor. The reactor contents were homogenized using a rotor/stator homogenizer, and polyaluminum chloride flocculant was added. The reactor was then heated to 52-59° C. for aggregation. The particle size (D50) was monitored using a Coulter Multisizer-3 instrument. The solids content at this stage was about 14 wt %. At a D50 value of about 5.7 μm, shell latex composed of poly(styrene-n-butyl acrylate) copolymer was added to the reactor using a metered pump. After 30 minutes, the slurry pH was increased to 4.6-4.8 by adding an aqueous 1 M NaOH solution and a chelating agent (VERSENE™ 100) solution. The reaction was then held for 10 minutes before heating to about 80° C. Aqueous 0.3 M nitric acid solution was added to lower the pH to 3.7-4.0, followed by heating to a coalescence temperature of 98° C. The reactor was held at the coalescence temperature until a circularity of 0.966 was achieved, as determined using a FPIA Sysmex 3000 instrument. An aqueous 1 M sodium hydroxide solution was then added to raise the pH to 6.0, and the reactor was then cooled to about 54° C. A solution of 55 g ammonium persulfate (4.8 molar equivalents relative to total o-anisidine and o-anisidine acetoacetamide) and 800 g deionized water was added. The resulting slurry was maintained at 54° C. for 30 minutes. A sample was taken for analysis and the pH was then further raised to 8.8 using 1 M aqueous sodium hydroxide solution. The reactor was then cooled to room temperature to produce a toner slurry containing solidified toner particles. The solidified toner particles in the slurry were then filtered, washed, and dried using typical methods to produce dry toner particles. Analytical data for this example is shown in Table 5.

Example 13. Toner particles were prepared and treated as in Example 12, except the aqueous solution contained 110 g ammonium persulfate (9.7 molar equivalents of oxidant relative to total o-anisidine and o-anisidine acetoacetamide) and 800 g of deionized water, and the reactor was only cooled to 70° C. before adding the oxidant solution. After adding the oxidant solution, the reactor was further cooled to 54° C. Analytical data for this example is shown in Table 5.

Example 14. Toner particles were prepared and treated as in Example 12, except the aqueous solution contained 165 g ammonium persulfate (14.5 molar equivalents of oxidant relative to total o-anisidine and o-anisidine acetoacetamide) and 800 g of deionized water, and the reactor was only cooled to 70° C. before adding the oxidant solution. After adding the oxidant solution, the reactor was further cooled to 54° C. Analytical data for this example is shown in Table 5.

TABLE 5

| | Molar | | | | |
|---|---|---|---|---|---|
| | Equiv. of | | | | |
| Example | APS | Treatment | Treatment | OA | AAOA |
| # | Oxidant | Time (hr) | Temp (° C.) | (ppm) | (ppm) |
| Comp. | n/a | n/a | n/a | 74 | 470 |
| Ex. 2 | | | | | |
| Ex. 12 | 4.8 | 0.5 | 54 | 47 | 420 |
| | 4.8 | 15 | 54 | 27 | 410 |
| Ex. 13 | 9.7 | 15 | 70 | 13 | 460 |
| Ex. 14 | 14.5 | 15 | 70 | 13 | 470 |

As shown, the various oxidation methods were effective to remove a significant percentage of the o-anisidine from toner particles at various stages of production thereof.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is the following:

1. A method comprising:
providing toner particles comprising an N-arylacetoacetarylide pigment composition, the N-arylacetoacetarylide pigment composition comprising a diazonium coupling product of a first aryl amine and an N-arylacetoacetamide formed from a second aryl amine;
wherein the N-arylacetoacetarylide pigment composition comprises at least some residual N-arylacetoacetamide that has not undergone diazonium coupling and/or at least some residual second aryl amine that has not reacted to form the N-arylacetoacetamide and/or has hydrolyzed from the N-arylacetoacetamide; and
contacting the toner particles with an oxidant in an aqueous phase at a temperature and for a time sufficient to decrease a concentration of at least the residual second aryl amine in the toner particles.

2. The method of claim 1, wherein the toner particles are core-shell toner particles and/or are prepared by an emulsion aggregation-coalescence process.

3. The method of claim 2, wherein the toner particles are prepared by the emulsion aggregation-coalescence process and are contacted with the oxidant during at least a portion of a coalescence stage of the emulsion aggregation-coalescence process.

4. The method of claim 3, wherein the coalescence stage takes place at a temperature above a glass transition temperature of the toner particles.

5. The method of claim 1, wherein the toner particles are obtained as a toner slurry from a toner production process, and the toner slurry is contacted with the oxidant.

6. The method of claim 1, wherein the toner particles are isolated as a solid prior to being contacted with the oxidant.

7. The method of claim 1, wherein the oxidant comprises a persulfate salt, a hypochlorite salt, or any combination thereof.

8. The method of claim 1, wherein a hydroxide compound, a carbonate salt, a bicarbonate salt, or any combination thereof is present in combination with the oxidant.

9. The method of claim 1, wherein the oxidant comprises a persulfate salt, and the temperature is about 25° C. to about 95° C.

10. The method of claim 9, wherein the time is about 0.5 hours to about 24 hours.

11. The method of claim 1, wherein the oxidant comprises a hypochlorite salt, and the temperature is about 25° C. to about 50° C.

12. The method of claim 1, wherein the N-arylacetoacetarylide pigment composition comprises an N-arylacetoacetarylide selected from the group consisting of Pigment Yellow 17, Pigment Yellow 74, Pigment Yellow 83, Pigment Yellow 180, and any combination thereof.

13. The method of claim 1, wherein the second aryl amine is o-anisidine.

14. The method of claim 1, wherein the temperature and time are sufficient to decrease the concentration of the second aryl amine by at least about 70% on a mass basis relative to an amount of the second aryl amine in the toner particles.

15. A toner composition comprising:
toner particles comprising an N-arylacetoacetarylide pigment composition, the N-arylacetoacetarylide pigment composition comprising a diazonium coupling product of a first aryl amine and an N-arylacetoacetamide formed from a second aryl amine;
wherein a concentration of residual second aryl amine in the toner particles is about 20 ppm or below.

16. The toner composition of claim 15, wherein the toner particles are core-shell toner particles and/or are prepared by an emulsion aggregation-coalescence process.

17. The toner composition of claim 15, wherein the N-arylacetoacetarylide pigment composition comprises an N-arylacetoacetarylide selected from the group consisting of Pigment Yellow 17, Pigment Yellow 74, Pigment Yellow 83, Pigment Yellow 180, and any combination thereof.

18. The toner composition of claim 15, wherein the second aryl amine is o-anisidine.
